(19) United States
(12) Patent Application Publication
(10) Pub. No.: US 2023/0275756 A1
(43) Pub. Date: Aug. 31, 2023

(54) ADAPTIVE KEY ROTATION BASED ON CRITICAL DATA IN STORAGE SYSTEM

(71) Applicant: Dell Products L.P., Round Rock, TX (US)

(72) Inventors: Rahul Deo Vishwakarma, Bangalore (IN); Parmeshwr Prasad, Bangalore (IN); Pooja Singh, Bangalore (IN)

(21) Appl. No.: 17/652,606

(22) Filed: Feb. 25, 2022

(51) Int. Cl. H04L 9/08

(52) U.S. Cl. CPC H04L 9/0891

(57) ABSTRACT

One example method includes identifying data attributes of a dataset that is protected by an encryption key, creating a causal model that indicates an impact that the data attributes have on each other and on a value of the dataset, determining, for each of the data attributes, and based on the causal model, an impact that each data attribute has on the value of the dataset, calculating, for each data attribute, a weight that indicates a magnitude of an impact that the data attribute has on the value of the dataset, calculating, using the weights, a criticality index for the dataset, and rotating, based on the criticality index, the encryption key so that the encryption key is replaced with a new encryption key.

### FIELD OF THE INVENTION

Embodiments of the present invention generally relate to data security. More particularly, at least some embodiments of the invention relate to systems, hardware, software, computer-readable media, and methods, for parameter-based adaptive encryption key rotation.

### BACKGROUND

The protection of enterprise digital assets, such as hardware, software, and data, from conscious misuse and attack is one of the key goals of any IT team and many teams have resorted to various encryption methods as a prime method to protect their data. Unfortunately, most of these solutions have fallen short in their ability to address the encryption key management challenges.

For example, most external encryption key managers provide automatic key rotation that is policy-based or schedule-based. However, such approaches to key rotation are problematic, at least because they provide ample time for any would-be hacker to understand the system and plan an attack.

With particular reference to automatic and policy based key rotation, such approaches may call, for example, for key rotation every 30, 60, or 90 days. However, these approaches are often tightly coupled to regulatory compliance and as such, are predictable, and not readily changed. Because of this, such approaches provide a ready attack surface for hackers that may lead to security breaches.

Another approach taken by some managers is manual key rotation, in which an encryption key is manually rotated, such as every hour for example. However, such manual approaches impose administrative overhead since they require the manager to perform the key rotation. Further, such approaches are prone to human error, since rotation of the key, on a timely basis, must be performed by a human.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture according to some embodiments.

FIG. 2 discloses a table of dataset attributes and corresponding descriptions.

FIG. 3 discloses a table of dataset attributes and associated symbols, according to some embodiments.

FIG. 4 discloses an example DAG (directed acyclic graph) according to some embodiments.

FIG. 5 discloses example SHAP scores such as may be calculated in some embodiments.

FIG. 6 discloses SHAP interaction values between various example data attributes.

FIG. 7 discloses a table of data attributes and their respective weights, according to some embodiments.

FIG. 8 discloses a table of datasets and their respective criticality index, according to some embodiments.

FIG. 9 discloses an example method according to some embodiments.

FIG. 10 discloses an example computing entity operable to perform any of the claimed methods, processes, and operations.

### DETAILED DESCRIPTION OF SOME EXAMPLE EMBODIMENTS

Embodiments of the present invention generally relate to data security. More particularly, at least some embodiments of the invention relate to systems, hardware, software, computer-readable media, and methods, for parameter-based adaptive encryption key rotation.

In general, example embodiments of the invention may operate to rotate encryption keys, which may be referred to herein simply as a ‘key,’ or ‘keys,’ with minimal administrative complexity so as to secure the data in the storage system. Thus, some example embodiments are directed to approaches which may operate to determine when to rotate a encryption key in a storage system of any encryption key manager, based on groupings of one or more parameters, examples of which are introduced briefly below. Key rotation may be performed automatically, and without warning, in some embodiments.

Particularly, key rotation may be based on the relative value of the data that is protected by the key. Thus, embodiments may operate to identify, and protect through key rotation, data that has been designated as ‘important’ for example. The data, and its importance level, may be identified as of a particular point in time, and may be identified while at rest in storage, and/or while in motion over a wire between computing entities.

Another parameter upon which key rotation may be based, according to some embodiments, is data volume. Particularly, a key may be rotated upon detection of an incoming high volume of data within a defined timespan. The amount of data, and timespan, may be calculated based on historical data and/or may constitute thresholds that may be set by an administrator.

A final example of a parameter upon which key rotation may be based is anomaly detection. Particularly, embodiments of the invention may automatically implement a key rotation upon detection of a specified, or unspecified, anomaly in the systems where data is stored, and/or systems over which, and to which, data is to be transmitted. Such anomalies may include, but are not limited to, security issues such as malicious access by a bad actor, and mutual trust violations. Any suitable anomaly detection technique(s) may be employed in such embodiments.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, some embodiments of the invention implement dynamic key rotation that is not tied to, nor constrained by, static elements such as key rotation schedules. Example embodiments may be responsive to anomalies and changing conditions in the environment where the protected data is stored, and may automatically implement key rotation upon detection of such anomalies and changing conditions. Example embodiments may reduce, or eliminate, human error that may occur in key rotation schemes where human involvement is required. Embodiments may predict when an anomaly is expected to occur, and my automatically implement key rotation in anticipation of the occurrence of the anomaly. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of Example Operating Environments

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

### B. Overview

As noted earlier, conventional approaches to key rotation are typically based on the domain knowledge of the administrator who triggers a manual key rotation. Other approaches, such as by cloud vendors, include periodic key rotation with specific time interval set by administrator. The following examples are illustrative.

In the Google Cloud environment, various guidelines (‘Google Guidelines’) are provided for key rotation. Details can be found at https://cloud.google.com/kms/docs/key-rotation, and some of these guidelines are set forth and discussed below.

The Google Guidelines, paraphrased hereafter, recommend that users rotate keys automatically on a regular schedule—A rotation schedule defines the frequency of rotation, and optionally the date and time when the first rotation occurs. The rotation schedule can be based on either the age of the key or the number or volume of messages encrypted with a key version. Some security regulations require periodic, automatic key rotation. Automatic key rotation at a defined period, such as every 90 days, increases security with minimal administrative complexity. You should also manually rotate a key if you suspect that it has been compromised, or when security guidelines require you to migrate an application to a stronger key algorithm. You can schedule a manual rotation for a date and time in the future. Manually rotating a key does not pause, modify, or otherwise impact an existing automatic rotation schedule for the key. See Google Guidelines.

Notably, the Google Guidelines make no reference to rotation of keys based on data criticality. Further, while reference in the Google Guidelines is made to message/data volume, the rotation of keys based simply on volume, with no consideration given to data criticality, may result in unnecessary key rotation for data that does not require that, and may fail to rotate keys for data that, while low in volume, may nonetheless be important data that requires protection. Thus, the Google Guidelines embody an inadequate approach to data protection.

Amazon Web Services (AWS) takes a similar approach to that of Google (see details at https://docs.aws.amazon.com/kms/latest/developerguide/rotate-keys.html). For example, AWS refers to manual key rotation, which requires a human administrator to perform the key rotation. As note earlier herein, manual key rotation is problematic. AWS also refers to automatic key rotation according to a set schedule, such as every 90 days. Like the Google Guidelines, AWS fails to tie, in any way, key rotation to data importance.

### C. Aspects of Some Example Embodiments

In order to determine when to rotate keys, example embodiments may implement a method which filters the incoming data, that is, the data that is, and/or will be, protected by the keys, into three phases and accordingly determines what action to take in which phase. The phases may be performed in a particular order, one example of which is discussed below, but that is not necessarily required. Thus, the numbers, such as ‘first phase,’ assigned herein to various phases are intended simply to facilitate the discussion, and are not intended to limit the scope of the invention in any way.

In a first phase of some example embodiments, the high value data within an ecosystem may be identified. For example, in a data center, there may be various storage servers whose key rotation is triggered from a central key manager server, which may be an external key manager. Embodiments may identify the data valuation of each data storage server in the datacenter, and define and implement a procedure that will trigger automated key rotation for the key that is used to protect the data. Data valuation may be performed inline as data is being ingested at a data center, and/or after the data has been stored at the data center.

In a second phase of some example embodiments, the volume of incoming new and/or modified data to one or more storage assets, such as storage servers for example, may be examined. If the incoming data to a storage server significantly exceeds historical values, then a call may be sent to an external key manager to override a key rotation policy, and rotate the associated key immediately or at some specified time, such as after the data volume has decreased to a specified level. Among other things, implementation of this second phase may serve to zero out the possibility of any security breach and information loss for high volumes of data.

A third phase of some example embodiments is generally concerned with malicious activities, such as the actual, attempted, or expected, access, theft, or compromise, of data. In this phase, a statistical/ML (machine learning) based anomaly detection approach and platform may be embodied in key rotation engine that may be implemented which may reside, for example, between a key manager layer and a storage server. Among other things, the key rotation engine may operate to predict when a malicious activity, such as concerning the data protected by the key, might occur in the future. A prediction may be based, for example, on historical system statistics such as, but not limited to, OS (operating system) logs, alerts, and error messages. Predictions made by the key rotation engine may also be assigned, by the key rotation engine or another entity, a likelihood of occurrence that indicates an assessment as to the likelihood that a predicted anomaly will actually occur. Finally, predictions may also be assigned, by the key rotation engine or another entity, a confidence level that indicates a relative confidence level that the likelihood assessment is correct. Once the system has ascertained that particular malicious behavior may occur at some point in the future, a message may be automatically generated by the system and passed to a key manager to trigger a key rotation for the key that protects the data of interest.

### C.1 Example Architecture

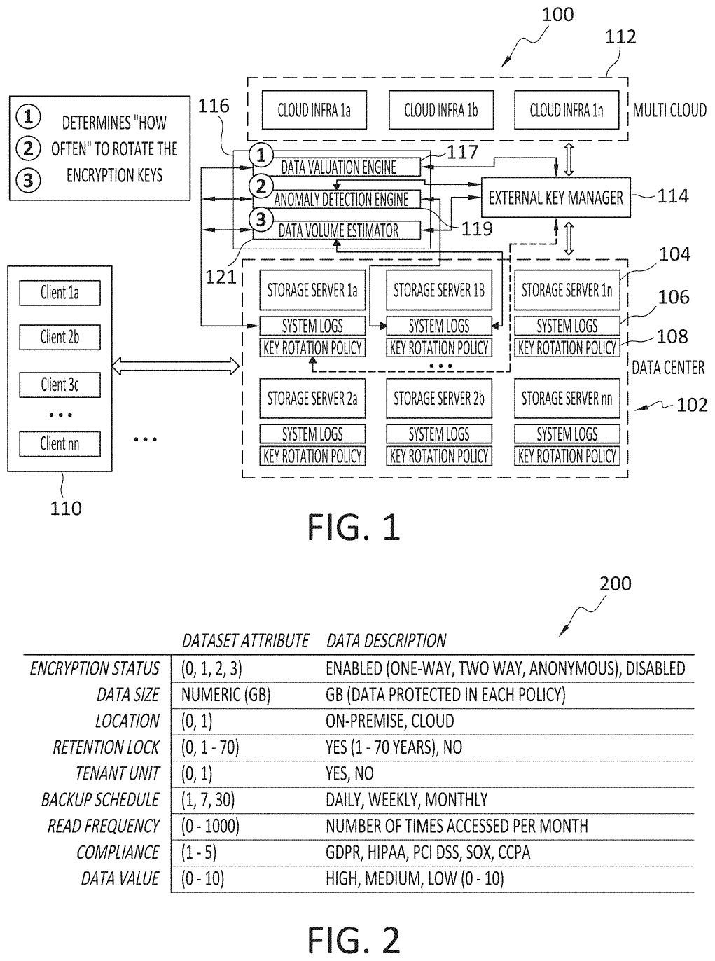

With attention now to FIG. 1, details are provided concerning an example architecture for some embodiments of the invention. Particularly, FIG. 1 discloses an example architecture 100 for implementation of embodiments of a method for adaptive key rotation in a data center. It is noted that the configuration provided in FIG. 1 is presented by way of illustration only, and is not intended to limit the scope of the invention in any way.

As shown in FIG. 1, the example architecture 100 may include a data center 102 that operates to retrievably store data, such as in one or more storage servers 104 for example. Each of the storage servers 104 may be associated with a respective set of system logs 106 which may, for example, operate to keep track of actual, and attempted, access of data stored in the storage servers 104. Further, a respective key rotation policy 108 may be associated with each of the storage servers 104. The key rotation policy 108 may be specifically tailored to data stored, and/or expected to be stored, at one of the storage servers 104.

The data center 102 may be accessed by a variety of entities, which may take various forms. For example, clients 110 may comprise enterprises that are able to directly access the data center 102 for the storage of client 110 data. In other cases, access to data in the data center 102 may take place by way of multi cloud environments 112 which may be owned and controlled by an enterprise.

Regardless of the type of entity that may access its data at the data center 102, key rotation functionality according to example embodiments may be provided to such entities. To this end, the data center 102 may comprise a key manager 114 that may operate to manage key rotation based on (1) the key rotation policy 108, and/or (2) inputs received by the key manager 114 from a key rotation engine 116.

The key rotation engine 116 may implement various functions, and the functions may be specifically implemented by respective modules. The performance of these functions may generate outputs that may be used by the key manager 114 as a basis for performing key rotations. For example, the key rotation engine 116 may include a data valuation engine 117 that operates to evaluate the relative importance of data which may be stored at the data center 102 and protected by a key. The data may be evaluated by the data valuation engine 117 in-line as the data is coming into the data center 102 and/or the data may be evaluated by the data valuation engine 117 after the data has been stored in the data center 102.

Note that it is possible that the relative importance, or valuation, of data may change after the data has been stored in the data center 102. In this case, the data may be reevaluated by the data valuation engine 117 and a key rotation policy pertaining to that data may be amended according to the change in the data importance. In some instances, the data valuation engine 117 may, on its own initiative, reevaluate stored data. Additionally, or alternatively, the data valuation engine 117 may periodically evaluate stored data as dictated by an established schedule.

With continued reference to FIG. 1, the key rotation engine 116 may further include an anomaly detection engine 119. In general, the anomaly detection engine 119 may be able to access system logs 106, and other sources of information concerning the access, or attempted access, of data stored in the data center 102. As well, the anomaly detection engine 119 may operate to forecast, such as based on historical information, the possible future occurrence of anomalies pertaining to the data stored in the data center 102. As such, the anomaly detection engine 119 may comprise an ML model that is operable to ingest historical information about the circumstances surrounding occurrence of one or more anomalies, and then generate predictions of anomaly occurrence based on that historical information.

Finally, the key rotation engine 116 may comprise a data volume estimator 121. In general, the data volume estimator 121 may operate to observe the volume of data coming into the data center 102 as a whole, and/or into one or more particular storage servers 104. The data volume estimator 121 may track the data volume over time on an ongoing basis, and/or may track the data volume over one or more defined discrete periods of time. As well, the data volume estimator 121 may issue a notification, such as to the external key manager 114, when the data volume per unit time, or over a defined period of time, exceeds a specified threshold.

Thus, the various example elements that may comprise one or more embodiments of the key rotation engine 116 may operate collectively, and individually, to define when a key rotation operation should be performed by the external key manager 114. That is, outputs generated by any, or all, of the elements of the key rotation engine 116 may form a basis for performance, possibly automatic, of a key rotation operation.

### C.2 Operational Aspects of Example Embodiments

As noted earlier, one phase, which may be referred to herein as a ‘first phase’ or ‘data valuation phase,’ of some example embodiments may involve systems and methods for valuing data, and such data valuations may be use to drive key rotation policies, and key rotation operations. Further, and as explained in connection with FIG. 1, data valuations and related operations may be performed by a data valuation engine of a key rotation engine.

The data valuation phase may be based on a causal model for variable selection and an explainable artificial intelligence method (XAI) for assigning the weights to the incoming data on a storage server, such as the storage server 104 for example. The causal model may operate based on various data attributes, that is, attributes of data that is, or may be, protected by storage in the data center 102. As noted earlier, data valuation may be performed repeatedly for data even after the data has been stored, since it is possible that data valuations may change with the passage of time. For example, data valued as ‘critical’ at the time of its storage, may be downgraded to ‘non-essential’ after 5 years, or after being tiered to archive storage.

Some example data attributes that may be employed in example embodiments of the invention are indicated in the table 200 in FIG. 2. These data attributes are provided only by way of example and are not intended to limit the scope of the invention. Thus, in some embodiments, additional, or alternative, data attributes may be employed. The data attributes may be gathered at any suitable level of a data storage infrastructure. In some embodiments, the data attributes are gathered on an individual storage server basis, but that is not necessarily required. For example, data attributes may be gathered on a group basis, such as for two or more storage servers.

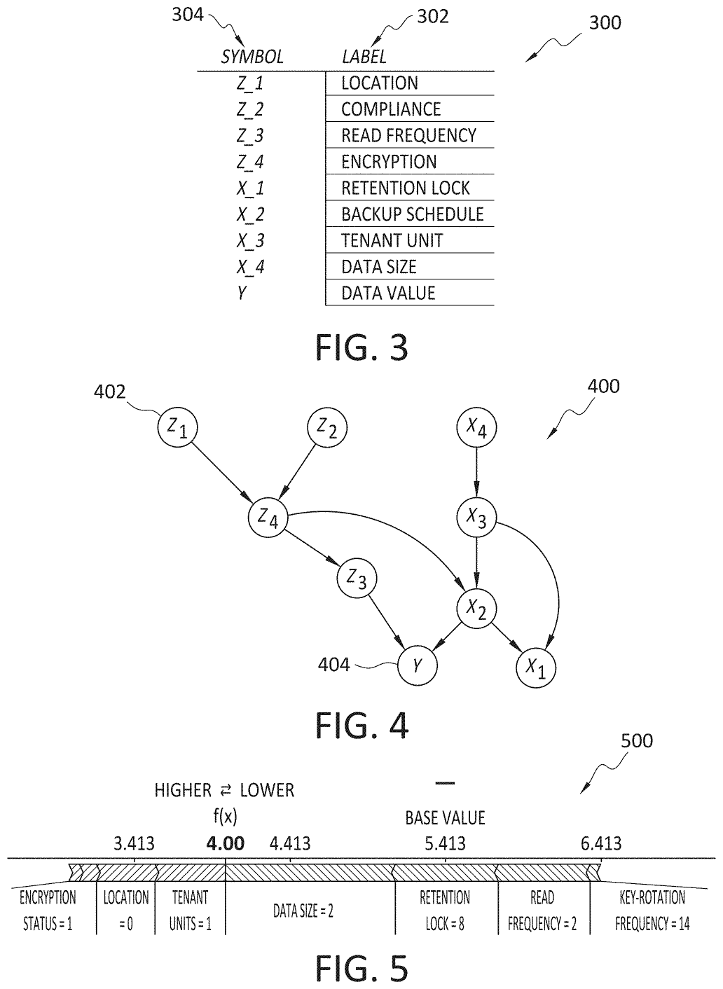

With reference next to FIG. 3, each of the data attributes shown in table 200 of FIG. 2 may be mapped to a respective symbol for use in a DAG, as shown in the example table 300. Particularly, the data attributes 302 may be mapped to the respective symbols 304.

Turning next to FIG. 4, an example DAG (directed acyclic graph) 400 is shown that may be employed in connection with, or as part of, a causal model. In general, the DAG 400 is a graphical representation of the data attributes that directly (for example, Z_3) or indirectly (for example, X_3) impact data value. That is, the DAG 400 may be constructed so that the causal impact of the various data attributes, on each other and, accordingly, on the value of the data in question, may be seen.

As shown, the DAG 400 may include a group of nodes 402, each of which may correspond to a respective data attribute. For example, the node 402 may correspond to the attributed denoted with the symbol Z_1, that, the location of the data that is being evaluated. Some, or all, of the nodes 402 may eventually point to a data value Y at node 404. That is, the information in the DAG 400 may be employed to ultimately determine the value of particular data.

Generally, embodiments may calculate, for each data attribute, the causal impact of that data attribute on one or more of the other data attributes, and only the attributes which show high impact for the overall model may be considered for data criticality index derivation. For example, based on the causal impact of the data attributes on the value of data Y, embodiments may select only the variables with relatively high causal impact and feed that information to a data attribute weight assignment process. As noted herein, the value of data may change over time and, in some cases, this change may result from changes to the impact imposed by one or more of the data attributes on the data value.

Note, in the example DAG 400, that the impact of a data attributes on data value may vary widely. For example, the data attribute Z_3 directly impacts data value. On the other hand, data attribute Z_4 only indirectly impacts data value. As a final example, the data attribute X_1 has no impact on the data value.

Example embodiments may employ input values, that is, data attributes, for estimating a SHAP (SHapley Additive exPlanations) score for each of the data attributes indicated in the DAG 400. In general, the SHAP approach provides a mechanism for explaining the decisions made by an ML model, and for explaining the output of an ML model. For example, the SHAP scores may explain or quantify the contribution, or impact, that each of the data attributes has on the data value that is ultimately determined. Following is an example of pseudocode that may be used to estimate SHAP scores:

import pandas as pd
df = pd.read_csv(‘data_valuation_estimation.csv’)
df.reset_index(drop=True, inplace=True)
X = df.drop(columns=[‘datavalue’])
y = df.iloc[:,8]
import xgboost
import shap
# load JS visualization code to notebook
shap.initjs( )
import xgboost
import shap
shap.initjs( )
model = xgboost.train({“learning_rate”: 0.68},
xgboost.DMatrix(X, label=y), 400)
explainer = shap.TreeExplainer(model)
shap_values = explainer.shap_values(X)
shap.force_plot(explainer.expected_value, shap_values [0,:], X.iloc[0,:])
shap_interaction_values = shap.TreeExplainer(model).
shap_interaction_values(X.iloc[:400,:])
shap.summary_plot(shap_interaction_values, X.iloc[:400,:])

With reference now to FIG. 5, an example SHAP value diagram 500 is shown. In general, for those data attributes that affect data value, and not all necessarily do, the effect of any given data attribute that does affect data value may be binary in nature. That is, a data attribute that does affect data value may do so in one of two ways. The data attribute may either increase, or decrease, the data value.

In the example of FIG. 5, it can be seen that the data attributes ‘encryption status’ (Z_4), ‘location’ (Z_1), and ‘tenant units’ (X_3), tend to increase data value. On the other hand, the data attributes ‘datasize’ (X_4), ‘retention lock’ (X_1), ‘read frequency’ (Z_3), and ‘key rotation frequency,’ tend to decrease data value.

The relative effects of the data attributes on data value can also be seen in FIG. 5. For example, it can be seen that ‘datasize’ (X_4) has the overall greatest impact on data value, while ‘key rotation frequency’ and ‘encryption status’ (Z_4) have a significantly smaller impact on data value as compared with the impact of ‘datasize’ (X_4). One possible explanation for the impact of ‘datasize’ (X_4) is that a relatively large dataset may be quite important, while a relatively small dataset may have reduced significance. Thus, the size of the dataset may, as shown in FIG. 5, significantly affect the value of the data.

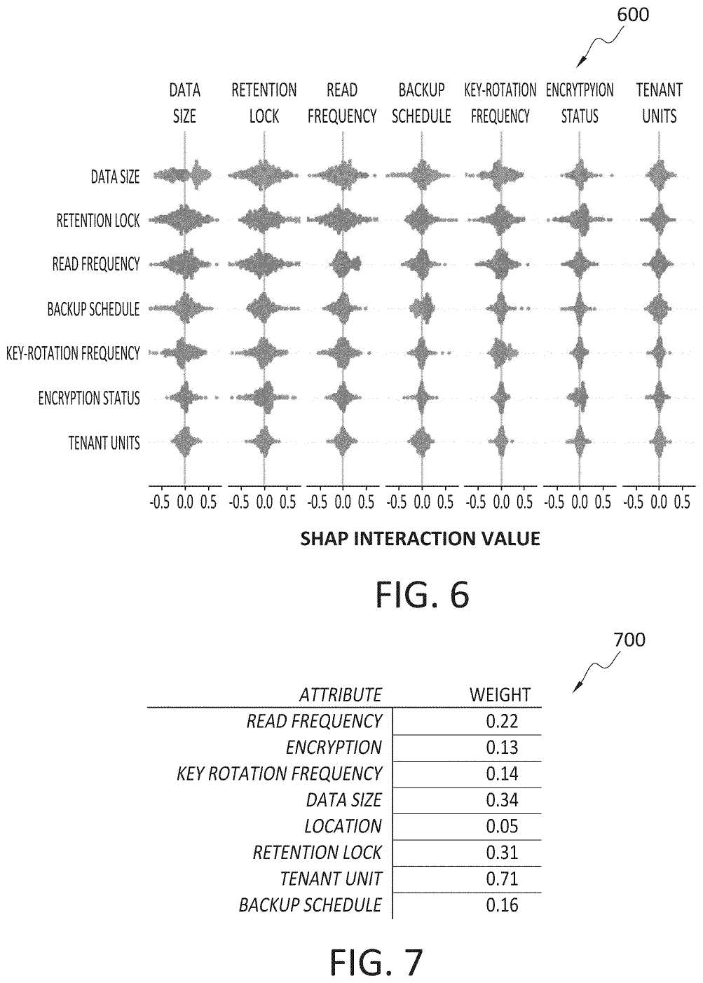

FIG. 6 includes a chart 600 that provides a graphical rendering of the interaction between various data attributes, and the corresponding SHAP values of those interactions. Color versions of FIGS. 5 and 6 are attached hereto as Appendix A, which forms a part of this disclosure. As shown in those color versions, the predominance of one data attribute over the other is reflected in the amount of color present in an interaction. The significance of the effect of one attribute on another is reflected in the overall size of the interaction, and the magnitude, positive or negative, of the SHAP score.

With reference next to FIG. 7, a table 700 is disclosed that includes a group of data attributes, and their respective weights. The weights may be, or correspond to, respective SHAP scores for the data attributes. As noted earlier, the magnitude of a SHAP score may indicate a relative extent to which the corresponding data attribute affects the value of the data. Thus, and with reference to the table 700, the data attribute ‘tenant unit’ has a relatively large weight, 0.71, while the data attribute ‘location’ (of the data) has a relatively small weight, 0.05. From this, it may be inferred that ‘tenant unit’ has a significantly greater affect on data value than does ‘location.’

In some embodiments, SHAP scores may be re-calculated on an ongoing basis, such as every 6 hours for example. For each such iteration, the respective SHAP scores of corresponding attributes may change depending on the data distribution. This is one reason the SHAP scores may be re-calculated each iteration, that is, every 6 hours in this example, and a criticality index may be calculated using the SHAP scores.

In particular, a criticality index for a dataset, which may be determined using weights such as those included in table 700, may be calculated as follows:

criticality_index=[(0.22*read_frequency)+(0.13*encryption)+(0.14*key_rotation_frequency)+(0.34*data_size)+(0.05*location)+(0.31*retention_lock)+(0.71*tenant_unit)+(0.16*backup_schedule)/(0.22+0.13+0.14+0.34+0.05+0.31+0.71+0.16)]

Following are some illustrative examples of criticality calculations, using the aforementioned approach.

### Example 1

Given: the following input features at time ‘t’=0600: read_frequency=34; encryption=1; key_rotation_frequency=90; data_size=865; location=0; retention_lock=0; tenant_unit=1; and, backup_schedule=30,

Then, the criticality_index is calculated as:

crticality_index_1=((0.22*read_requency)+(0.13*encryption)+(0.14*key_rotation_requency)+(0.34*data_size)+(0.05*location)+(0.31*retention_lock)+(0.71*tenant_unit)+(0.16*backup_schedule))/(0.22+0.13+0.14+0.34+0.05+0.31+0.7 1+0.16), or criticality_index_1=155.252427184466.

### Example 2

Given: the following input features at time ‘t’=2100: read_frequency=42; encryption=0; key_rotation_frequency=30; data_size=64; location=1; retention_lock=1; tenant_unit=1; and, backup_schedule=15.

Then, the criticality_index is calculated as:

criticality_index_2=((0.22*read_requency)+(0.13*encryption)+(0.14*key_rotation_requency)+(0.34*data_size)+(0.05*location)+(0.31*retention_lock)+(0.71*tenant_unit)+(0.16*backup_schedule))/(0.22+0.13+0.14+0.34+0.05+0.31+0.71+0.16), or criticality_index_2=18.771844660194176.

Similarly, embodiments may calculate a criticality_index_n as per the input values of features (dataset) at time n. Thus, a table as shown below may be generated.

| Dataset | Criticality Index |
|---|---|
| data_set_at_6_am (0600) | 155.252427184466 |
| data_set_9_pm (2100) | 18.771844660194176 |
| | 42 |
| | 87 |
| | 92 |
| | 147 |
| | 24 |
| | 97 |
| | 21 |
| | 19 |

Next, embodiments may scale the values in column “Criticality Index” so that the criticality_index values all fall in the range of 0.0 to 1.0. This scaling produces the following set of criticality values:
[1, 0, 0.17518248175182483, 0.5036496350364964, 0.5401459854014599, 0.9416058394160584, 0.043795620437956206, 0.5766423357664233, 0.021897810218978103, 0.0072992700729927005].

Below is example Javascript code operable to generate normalized criticality index values:

```
    function normalize(list) {
      var minMax = list.reduce((acc, value) => {
        if (value < acc.min) {
        acc.min = value;
        }
        if (value > acc.max) {
          acc.max = value;
        }
        return acc;
        }, {min: Number.POSITIVE_INFINITY, max:
  Number.NEGATIVE_INFINITY});
        return list.map(value => {
        // Verify that you're not about to divide by zero
        if (minMax.max=== minMax.min) {
        return 1 / list.length
        }
        var diff = minMax.max - minMax.min;
        return (value - minMax.min) / diff;
        });
        }
```

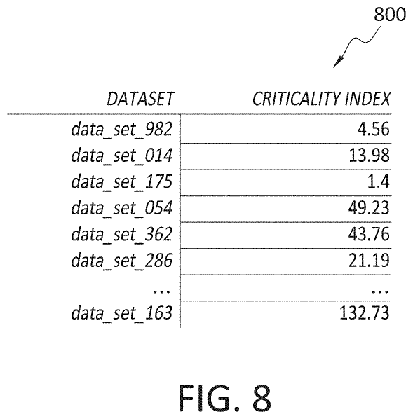

As indicated in the table 800 of FIG. 8, a criticality index may be calculated, for each of multiple data sets. A variety of criticality values are shown in table 800 ranging from 1.4 to 132.73. In the interest of readability, and interpretability, the criticality values in any given case may be scaled so that they all fall in a range extending from 0 to 1.0.

In general, the higher the criticality index of a dataset, the more important that data is for the business. Thus, the criticality index may serve as a basis for key rotation, and a key rotation policy. For example, key rotation may be performed more frequently for important, or valuable, data than for less valuable data.

In a similar way, data valuation for each storage server may be consolidated. That is, each storage server may be assigned an overall value that takes into account the respective values of the datasets residing on that storage server, as shown below.
Storage Server 1 {dataset_1a, dataset_2a, dataset_3a, . . . , dataset_an}
Storage Server 2 {dataset_1b, dataset_2b, dataset_3b, . . . , dataset_bn}
Storage Server 3 {dataset_1c, dataset_2c, dataset_3c, . . . , dataset_cn}
. . .
Storage Server n {dataset_1n, dataset_2n, dataset_3n, . . . , dataset_nn}

The data evaluation may be performed for each storage server and, for only the storage server, or storage servers, which has the highest value data at the time of evaluation, a key rotation may be triggered from a key manager hosted on a central key management server, and the existing key rotation is overridden.

### D. Further Discussion

As will be apparent from this disclosure, example embodiments may possess various useful features. For example, embodiments may operate to determine when, and how often, to rotate the encryption keys of a group of storage servers within a data center and multi cloud environment, based on data criticality, or value. As another example, embodiments may provide an explainable artificial intelligence (XAI) based on respective weight assignments to the data attributes for data valuation, for example, in order to comply with the GDPR right to explanation, and embodiments may further provide a causal model that may be used to select those features. Further, example embodiments may provide multi-objective optimization of impacting factors, such as data value, foresee malicious activity and volume of data, for example, and an amalgamation of these to understand the timing of encryption key rotation and the override of the existing key rotation schedule/policy.

The adaptive key rotation according to example embodiments may, in particular, provide that if a key is compromised, adaptive key rotation may operate to limit the number of actual messages that may be vulnerable to compromise, since the key rotation may be performed before a bad actor is able to access all the messages. As another example, adaptive key rotation may help to ensure that a system is resilient to manual rotation, whether due to a security breach or the need to migrate an application to a stronger cryptographic algorithm.

Adaptive key rotation according to example embodiments may be employed in a variety of circumstances. For example, adaptive key rotation may be employed in connection with data protection operations in which a remote disaster recovery site, using adaptive key rotation, may provide an uncompromised copy of data in case the primary backup becomes compromised. As another example, any storage server using adaptive external key rotation may have the ability to trigger additional key rotation when needed. As a final example, embodiments may enable the ability to secure data even in environments where there is no multifactor authorization or IAM (identity and access management) rules enabled.

### E. Example Methods

It is noted with respect to the example method of Figure(s) XX that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

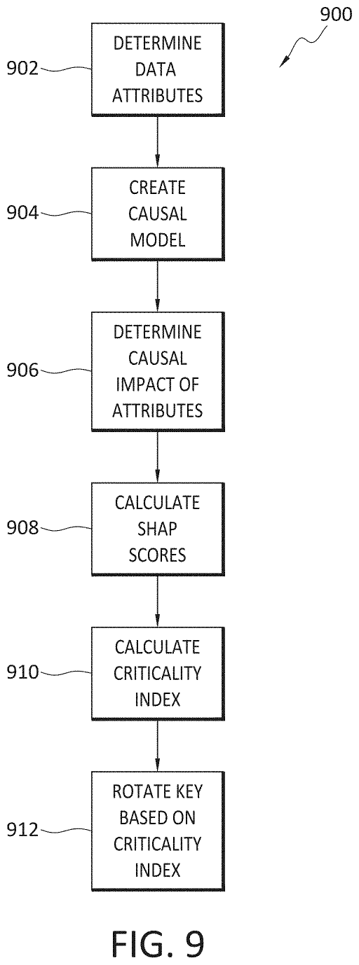

Directing attention now to FIG. 9, a method 900 is disclosed for implementing automatic key rotation based on a calculated value of data protected by a key. In some embodiments, part or all of the method 900 may be performed by a key rotation engine. In some embodiments, the method 900 may be cooperatively performed by a key rotation engine and a key manager. No particular functional allocation is required however, and the foregoing are provided only by way of example and are not intended to limit the scope of the invention in any way.

The method 900 may begin at 902 with the collection of attribute information concerning the data in question. Examples of data attributes are disclosed elsewhere herein and may include, for example, attributes such as backup schedule, data size, and data location.

The various data attributes may be used to create a causal model 904. The causal model, which may take the form of a DAG for example, may graphically depict which data attributes impact data value, and to what extent. The impact of a data attribute on data value may be due to direct impact of that data attribute on the data value and/or may be due to the impact of the data attribute on another data attribute which, in turn, directly impacts data value. Thus, the causal model may be used to determine the causal impact 906 of the data attributes on the value of the data.

Once it is determined whether and how data attributes affect the value of the data, a determination may then be made as to the extent to which each of those data attributes affects data value. Thus, the method 900 may calculate a SHAP score 908 for each of the data attributes known to impact data value. The SHAP scores may be considered as respective weights for each of the data attributes. Depending on its value, a SHAP score may cause an increase, or a decrease, in data value. The magnitude of the increase or decrease in data value is indicated by the absolute value of the SHAP score.

The SHAP scores may then be used to determine a criticality index 910 for the data. In some embodiments, only selected ones of the SHAP scores may be employed to determine the criticality index for the data, where the criticality index quantifies the relative value of the data. For example, a relatively low SHAP score, indicating minimal impact of the associated data attributed on the data value, may be omitted from the calculation of a criticality index. In some embodiments, only SHAP scores that equal or exceed a defined threshold may be used to calculate a criticality index.

Finally, a key rotation scheme may be defined and implemented 912, based on the value of the criticality index. For example, if the criticality index is below a defined threshold, periodic key rotation according to a defined schedule may provide adequate data security. On the other hand, if the criticality index equals or exceeds a defined threshold, key rotation for the associated data may be performed automatically, and on a relatively frequent basis, to ensure that the data remains secure.

In some embodiments, key rotation may be performed immediately after the criticality index has been determined. In some cases, this key rotation may override an existing key rotation policy that has been established for the data. Further, a key rotation policy may be modified, possibly automatically, in response to a change to the calculated criticality index of the data.

The method 900 may be performed on an iterative basis, such as daily for example, and/or may be performed on an ad hoc basis upon instantiation by a user, or by a computing entity, for example. Key rotation may, or may not, be performed after each iteration of the method 900.

### F. Further Example Embodiments

Following are some further example embodiments of the invention. These are presented only by way of example and are not intended to limit the scope of the invention in any way.

Embodiment 1. A method, comprising: identifying data attributes of a dataset that is protected by an encryption key; creating a causal model that indicates an impact that the data attributes have on each other and on a value of the dataset; determining, for each of the data attributes, and based on the causal model, an impact that each data attribute has on the value of the dataset; calculating, for each data attribute, a weight that indicates a magnitude of an impact that the data attribute has on the value of the dataset; calculating, using the weights, a criticality index for the dataset; and rotating, based on the criticality index, the encryption key so that the encryption key is replaced with a new encryption key.

Embodiment 2. The method as recited in embodiment 1, wherein the causal model comprises a DAG, and each node of the DAG corresponds to a respective data attribute.

Embodiment 3. The method as recited any of embodiments 1-2, wherein calculating a weight for each data attribute comprises calculating a SHAP score for each data attribute.

Embodiment 4. The method as recited in embodiment 3, wherein each SHAP score indicates (1) whether the associated data attribute increases or decreases the value of the dataset, and (2) a magnitude of the increase or the decrease.

Embodiment 5. The method as recited any of embodiments 1-4, wherein rotating the encryption key overrides an existing encryption key rotation policy.

Embodiment 6. The method as recited any of embodiments 1-5, wherein rotating the encryption key is also based on detection of an anomaly relating to the dataset.

Embodiment 7. The method as recited any of embodiments 1-6, wherein rotating the encryption key is also based on a volume of the dataset.

Embodiment 8. The method as recited any of embodiments 1-7, further comprising calculating a criticality index for one or more additional datasets and, based on the criticality index of the dataset and the respective criticality index for the additional datasets, calculating a criticality index for a storage server that stores the dataset and the additional datasets.

Embodiment 9. The method as recited any of embodiments 1-8, wherein rotating the encryption key is performed when the criticality index of the dataset equals or exceeds a defined threshold.

Embodiment 10. The method as recited any of embodiments 1-9, wherein rotating the encryption key is performed automatically.

Embodiment 11. A system, comprising hardware and/or software, for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

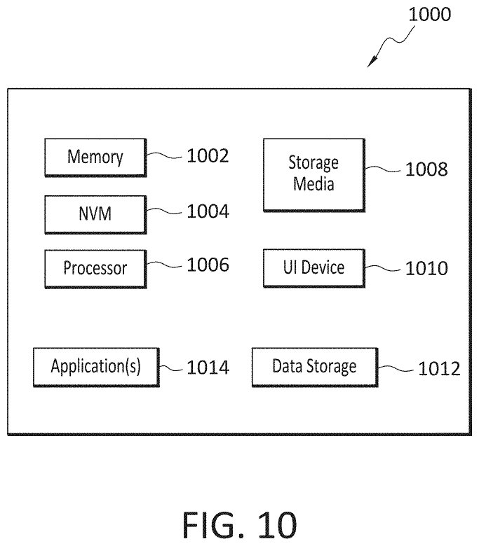

With reference briefly now to FIG. 10, any one or more of the entities disclosed, or implied, by FIGS. 1-9 and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
identifying data attributes of a dataset that is protected by an encryption key;
creating a causal model that indicates an impact that the data attributes have on each other and on a value of the dataset;
determining, for each of the data attributes, and based on the causal model, an impact that each data attribute has on the value of the dataset;
calculating, for each data attribute, a weight that indicates a magnitude of an impact that the data attribute has on the value of the dataset;
calculating, using the weights, a criticality_index for the dataset; and
rotating, based on the criticality_index, the encryption key so that the encryption key is replaced with a new encryption key.

2. The method as recited in claim 1, wherein the causal model comprises a DAG, and each node of the DAG corresponds to a respective data attribute.

3. The method as recited in claim 1, wherein calculating a weight for each data attribute comprises calculating a SHAP score for each data attribute.

4. The method as recited in claim 3, wherein each SHAP score indicates (1) whether the associated data attribute increases or decreases the value of the dataset, and (2) a magnitude of the increase or the decrease.

5. The method as recited in claim 1, wherein rotating the encryption key overrides an existing encryption key rotation policy.

6. The method as recited in claim 1, wherein rotating the encryption key is also based on detection of an anomaly relating to the dataset.

7. The method as recited in claim 1, wherein rotating the encryption key is also based on a volume of the dataset.

8. The method as recited in claim 1, further comprising calculating a criticality index for one or more additional datasets and, based on the criticality index of the dataset and the respective criticality index for the additional datasets, calculating a criticality index for a storage server that stores the dataset and the additional datasets.

9. The method as recited in claim 1, wherein rotating the encryption key is performed when the criticality index of the dataset equals or exceeds a defined threshold.

10. The method as recited in claim 1, wherein rotating the encryption key is performed automatically.

11. A non-transitory storage medium having stored therein instructions that are executable by one or more hardware processors to perform operations comprising:
identifying data attributes of a dataset that is protected by an encryption key;
creating a causal model that indicates an impact that the data attributes have on each other and on a value of the dataset;
determining, for each of the data attributes, and based on the causal model, an impact that each data attribute has on the value of the dataset;
calculating, for each data attribute, a weight that indicates a magnitude of an impact that the data attribute has on the value of the dataset;
calculating, using the weights, a criticality index for the dataset; and
rotating, based on the criticality index, the encryption key so that the encryption key is replaced with a new encryption key.

12. The non-transitory storage medium as recited in claim 11, wherein the causal model comprises a DAG, and each node of the DAG corresponds to a respective data attribute.

13. The non-transitory storage medium as recited in claim 11, wherein calculating a weight for each data attribute comprises calculating a SHAP score for each data attribute.

14. The non-transitory storage medium as recited in claim 13, wherein each SHAP score indicates (1) whether the associated data attribute increases or decreases the value of the dataset, and (2) a magnitude of the increase or the decrease.

15. The non-transitory storage medium as recited in claim 11, wherein rotating the encryption key overrides an existing encryption key rotation policy.

16. The non-transitory storage medium as recited in claim 11, wherein rotating the encryption key is also based on detection of an anomaly relating to the dataset.

17. The non-transitory storage medium as recited in claim 11, wherein rotating the encryption key is also based on a volume of the dataset.

18. The non-transitory storage medium as recited in claim 11, further comprising calculating a criticality index for one or more additional datasets and, based on the criticality index of the dataset and the respective criticality index for the additional datasets, calculating a criticality index for a storage server that stores the dataset and the additional datasets.

19. The non-transitory storage medium as recited in claim 11, wherein rotating the encryption key is performed when the criticality index of the dataset equals or exceeds a defined threshold.

20. The non-transitory storage medium as recited in claim 11, wherein rotating the encryption key is performed automatically.
